(19) United States
(12) Patent Application Publication
(10) Pub. No.: US 2022/0067590 A1
(43) Pub. Date: Mar. 3, 2022

(54) AUTOMATIC KNOWLEDGE GRAPH CONSTRUCTION

(71) Applicant: International Business Machines Corporation, Armonk, NY (US)

(72) Inventors: Leonidas Georgopoulos, Zürich (CH); Dimitrios Christofidellis, Zürich (CH)

(21) Appl. No.: 17/005,805

(22) Filed: Aug. 28, 2020

(51) Int. Cl. G06N 20/20; G06N 5/04; G06N 5/02; G06F 40/279; G06F 40/205

(52) U.S. Cl. CPC G06N 20/20; G06N 5/04; G06N 5/003; G06F 40/279; G06F 40/205; G06N 5/022

(57) ABSTRACT

In an approach for automatic knowledge graph construction, a processor receives a text document and trains a first machine-learning system to predict entities in the text document. Thereby, the text document with labeled entities is used as training data. A processor trains a second machine-learning system to predict relationship data between the entities, wherein, as training data, entities and edges of an existing knowledge graph and determined embedding vectors of the entities and edges are used. A processor receives a set of second text documents, determines second embedding vectors therefrom, and predicts entities and edges; thereby using the set of second text documents, the determined second embedding vectors, and the predicted entities and associated embedding vectors of the predicted entities as input for the first and second trained machine-learning model. A processor builds triplets of the entities and the edges representing a new knowledge graph.

### BACKGROUND

The invention relates generally to knowledge graphs, and more specifically, to automatic knowledge graph construction with automatic knowledge definition.

Artificial intelligence (AI) is one of the hottest topics in the information technology (IT) industry. It is one of the fastest developing areas in technology. A lack of available skills in parallel to the fast development of large amounts of algorithms and systems makes the situation even worse. Enterprises and research institutes have started some time ago to organize knowledge and data as knowledge graphs comprising facts and relationships between the facts. However, the construction of knowledge graphs from the ever-growing amount of data is a labor-intensive and not well-defined process. A lot of experience is required.

Currently, a typical approach is to define specific parsers and run them against for a corpus of information, e.g., a plurality of documents, in order to recognize relationships between facts and assign specific weights to them. The expert then has to put them together in a newly to be built knowledge graph. Defining, coding, and maintaining parsers in the ever-changing context of big data and maintaining the associated infrastructure is a difficult task, even for the largest companies and organizations. The parsers are typically content and knowledge domain specific and their development may require highly skilled people. Thus, a parser, developed for a specific knowledge domain, cannot be used in a one-to-one fashion for another corpus and/or another knowledge domain.

### SUMMARY

According to one aspect of the present invention, a method for building a new knowledge graph may be provided. The method may comprise receiving a first text document and training of a first machine-learning system to develop a first prediction model adapted to predict entities in the received text document. Thereby, the text document with labeled entities from the text document is used as training data.

Furthermore, the method may comprise training of a second machine-learning system to develop a second prediction model adapted to predict relationship data between the entities. Thereby, entities and edges of an existing knowledge graph and determined first embedding vectors of the entities and the edges are used as training data.

Additionally, the method may comprise receiving a set of second text documents, determining second embedding vectors from text segments from documents from the second set of documents, predicting entities in the set of second text documents by using the set of second text documents and the determined second embedding vectors as input for the first trained machine-learning model, predicting edges in the set of second text documents by using the predicted entities and associated embedding vectors of the predicted entities as input for the second trained machine-learning model, and building triplets of the predicted entities and the related predicted edges which combined may build the new knowledge graph.

According to another aspect of the present invention, a knowledge graph construction system for building a knowledge graph may be provided. The knowledge graph construction system may comprise one or more computer processors, one or more computer readable storage media, and program instructions stored on the computer readable storage media for execution by at least one of the one or more processors of the method as described above.

According to yet another aspect of the present invention, a computer program product for building a knowledge graph may be provided. The computer program product may comprise one or more computer readable storage media and program instructions stored on the one or more computer readable storage media to execute the method as described above.

In the following, additional embodiments—applicable to the method as well as to the related system and computer program product—will be described.

According to an embodiment, the method may also comprise removing the predicted entity from a group of all predicted entities, if the predicted entity has a confidence level value below a predetermined entity threshold value. This may be a reduction in “noise in the system”, i.e., a pruning of predicted entities for which the prediction resulted in a low confidence value for the prediction. The threshold value may be configured to adapt the system behavior to different input documents and prediction algorithms.

According to an embodiment, the method may also comprise removing a predicted edge from a group of all predicted edges, if the predicted edge has a confidence level value below a predetermined edge threshold value. Thus, the pruning effect may be implemented in a manner similar to the pruning function for the entities.

According to an embodiment of the method, the first machine-learning system and the second machine-learning system may be trained using a supervised machine-learning method. The training method is a proven method if enough qualified training data are available. It may be assumed that this is the case here, since the training may need to be carried out only once on a document or a small set of documents, wherein entities and potential relationships may be labeled using, for example, a dedicated parser or an expert. Alternatively, the dedicated parser may be used first and in preparation of labeling of the entities and the human expert may confirm/validate or correct the machine-made labeling by the dedicated parser.

According to an embodiment of the method, the supervised machine-learning method for the first machine-learning system may be a random forest machine-learning method. The random forest model is highly proven for supervised machine-learning tasks. It may denote an ensemble learning method for the herein required classification. The random forest method may build a multitude of decision trees at training time and may output the class that is the mode of the classes (i.e., classification) of the individual trees.

According to another embodiment of the method, the second machine-learning system may be a neural network system, a reinforcement learning system, or a sequence-to-sequence machine-learning system.

According to one embodiment of the method, the entity is an entity type. Hence, a plurality of entities applicable to the same topic may be treated as entity type. Therefore, a rose flower, a sunflower, or a peony flower may all be related to the entity “flower”. As a consequence, and according to another embodiment, the method may also comprise executing a parser for each predicted entity, thereby, determining at least one entity instance. Hence, as an example, if the entity (i.e., the entity type) may be “city name”, an instance may be, e.g., “Yorktown Heights”, “Almaden”, or “Rueschlikon”.

According to an embodiment of the method, the first document may also be a plurality of documents. This may represent a bigger corpus to extract the knowledge of a certain knowledge domain to be used as a sample to learn entities and relationships between these entities. Basically, it may increase the number of available training data for the first machine-learning system and the second machine-learning system.

According to an embodiment, the method may also comprise storing provenance data—i.e., reference data or source reference pointers—to the document of the second set of documents for the predicted entities and/or predicted edges together with triplets. Thus, this provenance data may be stored as metadata together with a triplet, e.g., in the same record. Therefore, an associated storage record may not only comprise the edge and the associated entities, but also where they may have found. This may increase the trust in the newly built knowledge graph in order to fulfill requirements for explainable AI.

According to an embodiment of the method, the set of documents may be at least one of an article, a book, a newspaper, conference proceedings, a magazine, a chat protocol, a manuscript, handwritten notes—in particular after having undergone an OCR (optical character recognition) process—a server log, and an email thread. Basically, every machine-readable document may be used. Advantageously, all the used documents may relate to the same knowledge domain.

According to an embodiment, the method may also comprise using the determined first embedding vectors of the labeled entities as input for the training of the first machine-learning model. This may increase the accuracy of the trained model and may allow a quick and fast prediction of the entities in the deployment phase of the present invention.

### BRIEF DESCRIPTION OF THE SEVERAL VIEWS OF THE DRAWINGS

FIG. 1 depicts a flowchart of the steps of a method for building a new knowledge graph, in accordance with an embodiment of the present invention.

FIG. 2 depicts a block diagram of the method for building a new knowledge graph, in accordance with an embodiment of the present invention.

FIG. 3 depicts a block diagram of a training phase, in accordance with an embodiment of the present invention.

FIG. 4 depicts a block diagram of a deployment phase, in accordance with an embodiment of the present invention.

FIG. 5 depicts a block diagram of a knowledge graph construction system, in accordance with an embodiment of the present invention.

FIG. 6 depicts a block diagram of a computing device comprising the knowledge graph construction system, in accordance with an embodiment of the present invention.

### DETAILED DESCRIPTION

In the context of this description, the following conventions, terms and/or expressions may be used:

The term ‘knowledge graph’ may denote a data structure comprising vertices and edges linking selected ones of the vertices. A vertex may represent a fact, term, phrase, or word, and an edge between two vertices may express that a relationship may exist between the linked vertices. The edge may also carry a weight, i.e., a weight value may be assigned to each of the plurality of edges. A knowledge graph may comprise thousands or millions vertices and even more edges. Different types of structures are known hierarchical or circular or spherical ones with no real center or origin. Knowledge graphs may grow by adding new terms (i.e., vertices and then link then via new edges to existing vertices. A knowledge graph may also be organized as a plurality of edges with two vertices each. Storage forms for knowledge graphs may vary; one form may be to store triplets of an edge with two related vertices.

The term ‘new knowledge graph’ may denote a knowledge graph that does not exist before the herein method has been executed. It may be constructed in a fully automated fashion based on existing documents of a pre-defined knowledge domain and a second corpus as the basis for the newly constructed knowledge graph.

In contrast, the term ‘existing knowledge graph’ may denote a knowledge graph that may exist before the herein method may be executed. It may basically represent a blueprint of the domain knowledge structure that may be fine-tuned by the first document(s) during the training of the first and second machine-learning systems.

The term ‘first text document’—or a plurality thereof—may denote a text document used to define the domain specificity. From this document—which may, in particular, and in practice be also a plurality of documents of the selected knowledge domain—the core knowledge may be extracted from this document by learning (i.e., supervised learning) to identify entities and edges using two different machine-learning systems. The existing knowledge graph may contribute basic dependencies (i.e., relations between terms words and/or phrases), entities or vertices.

The term ‘machine-learning’—and based on that the term ‘machine-learning model’—may denote known methods of enabling a computer system that may improve its capabilities automatically through experience and/or repetition without procedural programming. Thereby, machine-learning can be seen as a subset of AI. Machine-learning algorithms may build a mathematical model—i.e., the machine-learning model—based on labeled sample data, known as “training data”, in order to make predictions or decisions without being explicitly programmed to do so. One implementation option may be to use a neural network comprising nodes for storing fact values and/or a transformation function to transform incoming signal. Furthermore, selected ones of the nodes may be linked to each other by edges (i.e., connections, relationship data), potentially having a weight factor (i.e., expressing a strength of the link which may be interpreted as an input signal for one of the cores). Beside neural networks with only 3 layers of cores (input layer, hidden layer, output layer), also neural networks with a. plurality of hidden layers of various forms exist (i.e., deep neural network).

The term ‘supervised machine-learning’ may denote a training form for a machine-learning model in which the training data also include the results to be learned. These results come typically in the form of expected results, i.e., labeled data into the training process. Unsupervised learning contrasts supervised learning in that no labeling is provided for the training data.

The term ‘first prediction model’ may denote a machine-learning model to be trained with labeled terms—i.e., entities—from the given first document or documents.

The term ‘entity’ may denote a value to be stored in a node, core, or vertex of a knowledge graph.

The term ‘labeled entity’ may denote a term or word—in particular, a fact or subject—envisioned as a potential vertex in the to-be-built knowledge graph. However, the labeled entity is a term or word within the first document to which a label has been added, e.g., by an expert (alternatively, by another machine-learning system or a machine-learning supported parser).

The term ‘relationship data’ may denote edge data in a knowledge graph. They may define the relationship between two entities. As an example, if the two entities are “money” and “banana”, potential relationship data may be “is liked” or “is eaten”.

The term ‘embedding vector’ may denote a vector with real value components generated from a term, word, or phrase. Generally, word embedding may denote the collective name for a set of language modeling and feature learning techniques in natural language processing (NLP) where words or phrases from the vocabulary are mapped to vectors of real numbers. Conceptually, it may involve a mathematical embedding from a space with many dimensions per word to a continuous vector space with a much lower dimension. Methods to generate this mapping include neural networks, dimensionality reductions in the word co-occurrence matrix probabilistic models, explainable knowledge base methods, and explicit representation in terms of the context in which words appear.

The term ‘set of second text documents’ may denote a corpus of data or knowledge preferably related to a specific knowledge domain. It may come in various forms of which an article, a book, a whitepaper, a newspaper, conference proceedings, a magazine, a chat protocol, a manuscript, handwritten notes, a server log, or an email thread are only examples. Any mixture may be allowed. It may start with only one document and may, e.g., also comprise a complete library, i.e., a public library, a library of a research institute, or an enterprise library comprising all handbooks of the company. On the other hand, it may be as small as a chat protocol between two programmers regarding a specific problem.

The term ‘triplet’ may denote a group comprising two entities, i.e., two entity values, and a related edge, i.e., edge value. Again, as example, if the two entities are “money” and “banana”, the edge may be “is liked” or “is eaten”.

The term ‘confidence level value’ may denote a real number expressing how sure the first (or second) machine-learning model is about a specific prediction value. A comparably low confidence level value (e.g., 0.4, in particular, configurable) may express that a prediction regarding an entity or an edge may be regarded as potential error. Hence, the prediction may be omitted, i.e., not treated as predicted edge or entity. This may achieve a robustness of the proposed concept against “data noise”.

The term ‘neural network system’—or more precisely, artificial neural network—may denote computing systems inspired by the biological neural networks that constitute animal brains. The data structures and functionality of neural networks are designed to simulate associative memory. Neural networks learn by processing examples, each of which contains a known “input” and “result,” forming probability-weighted associations between the two, which are stored within the data structure of the net itself. Thus, the neural network becomes enabled to predict results together with a confidentiality value for the prediction based on an input. For example, an image as input data may be classified as “comprises a picture of a cat” with 90% confidentiality. A neural network may comprise a plurality of hidden layers in addition to an input layer and an output layer of artificial neural nodes.

The term ‘reinforcement learning system’ may denote also an area of machine-learning concerned with how software agents ought to take actions in an environment in order to maximize the notion of cumulative reward. Reinforcement learning is one of three basic machine-learning paradigms, alongside supervised learning and unsupervised learning. Reinforcement learning differs from supervised learning in not needing labeled input/output pairs be presented, and in not needing sub-optimal actions to be explicitly corrected. Instead, the focus is on finding a balance between exploration (of uncharted territory) and exploitation (of current knowledge).

The environment may typically be stated in the form of a Markov decision process (MDP) because many reinforcement learning algorithms for this context may utilize dynamic programming techniques. The main difference between classical dynamic programming methods and reinforcement learning algorithms is that the latter do not require knowledge of an exact mathematical model of the MDP and are aimed at target large MDPs where precise methods are no longer feasible.

The term ‘sequence-to-sequence machine-learning model’ (seq2seq) may denote a method or system transforming one sequence of symbols into another sequence of symbols. It does so by use of a recurrent neural network (RNN) or more often Long Short-Term Memory (LSTM) or Grated Recurrent Unit (GRU) to avoid the problem of a vanishing gradient. The context for each item is the output from the previous step. The primary components are one encoder and one decoder network. The encoder turns each item into a corresponding hidden vector containing the item and its context. The decoder reverses the process, turning the vector into an output item, using the previous output as the input context. The seq2seq system may typically be comprised of three parts: encoder, intermediate (encoder) vector, and decoder.

The term ‘entity type’ may denote a group identifier for a group of entities. For example, as group identifier for the group comprising scooter, bicycle, motor bike, car, truck, pickup, etc., the term “vehicle” may be used.

The term ‘entity instance’ may denote a specific group member in the above sense. An alternative example may be the entity type car with entity instances being of a specific make.

The term ‘provenance data’ may denote metadata for a given entity or edge in the newly constructed knowledge graph. The provenance data may be implemented as pointers to data sources in the second corpus relating to entities and edges in the new knowledge graph pointing to “prove data”, indicating the source of the entities and relationships. Hence, it may be seen as a contribution to explainable AI.

A disadvantage of known solutions may be that domain knowledge must be known in order to make the known techniques efficient, so they do not result in misleading knowledge graph constructions. However, there may be a need to overcome the known deficiencies of traditional technologies, in particular, how to overcome and acquire unknown domain knowledge to efficiently construct a new knowledge graph.

The proposed aspects for building a new knowledge graph may offer multiple technical advantages, technical effects, contributions and/or improvements.

The technical problem of automatically building a new knowledge graph is addressed. This way, new knowledge graphs may be automatically generated more easily and faster and may require less highly skilled experts when compared to traditional approaches. The new knowledge graphs may also be generated as a service by a service provider. For this, an existing knowledge graph typically of a specific knowledge domain may be used to train a machine-learning model system in order to generate the new knowledge graph from a new corpus of documents without additional human intervention.

Even better, a plurality of new knowledge graphs may be automatically constructed from different new corpuses while reusing the development of the first and the second machine-learning model again and again. This may allow extracting domain specific knowledge once from a first corpus and using that extracted knowledge to apply it to the generation of a plurality of new, but different, knowledge graphs based on the new text sources. This may allow offering a knowledge graph construction service for different customers based on their user specific text corpuses.

A wide variety of documents as the basis for the new corpus may be used, as detailed below. The documents do not have to be prepared in a specific way. However, the documents may be pre-processed as part of the present invention herein.

The principle of the present invention herein may be based on the fact that terms and phrases may be related more closely to one another the closer related embedding vectors are to one another, i.e., the closer the relative embedding vectors are to each other.

Hence, a plurality of new knowledge graphs may be generated automatically based on the core technology of an existing domain specific document(s) and a trained machine-learning system specific to the knowledge domain. No highly skilled personnel are required and the generation of the newly constructed knowledge graph can be executed fully automated and provided as a service.

In the following, a detailed description of the figures will be given. All instructions in the figures are schematic. Firstly, a flowchart of the steps of a method for building a new knowledge graph, in accordance with an embodiment of the present invention, is given. Afterwards, further embodiments, as well as embodiments of the knowledge graph construction system for building a knowledge graph, will be described.

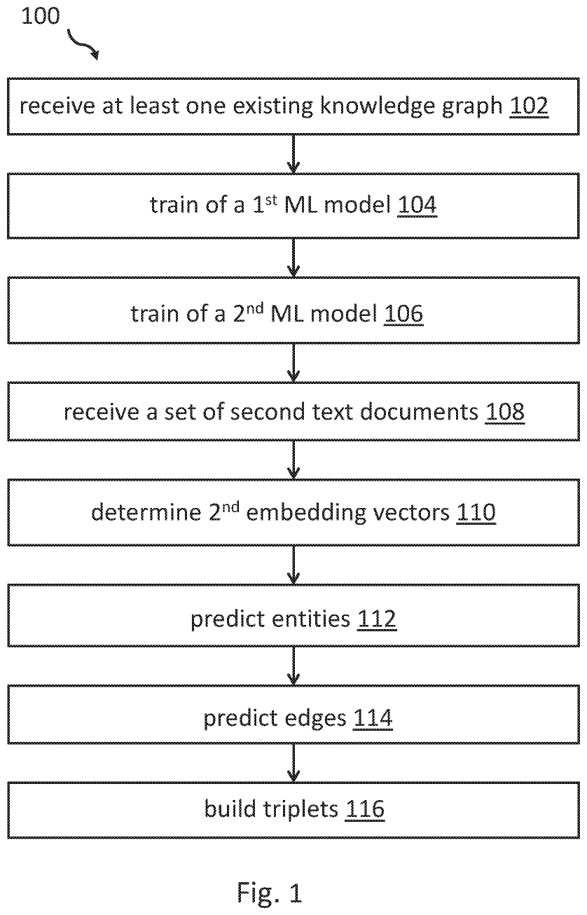

FIG. 1 shows a flowchart of an embodiment of method 100 for building a new knowledge graph that comprises vertices and edges, wherein the edges describe relationships between vertices and the vertices relate to entities, e.g., words. Method 100 comprises receiving 102 a first text document. The text document should relate to a defined knowledge domain. In general, the text document comprises a plurality of text documents or different kinds of documents building together a corpus of documents.

Method 100 comprises training 104 of a first machine-learning system to develop a first prediction model adapted to predict entities in the received text document, wherein the text document with labeled entities from the text document is used as training data. It may also be noted that the labeled entities should be suitable as nodes or cores or facts in a knowledge graph.

Furthermore, method 100 comprises training 106 of a second machine-learning system to develop a second prediction model adapted to predict relationship data—in particular, to be usable as edges in a knowledge graph—between the entities. Thereby, entities and edges—i.e., the relationships—of an existing knowledge graph and determined first embedding vectors of the entities and the edges are used as training data. It may be noted that the existing knowledge graph shall ideally be created and/or curated by an expert. Also, more than one expert may be used, and more than one knowledge graph may be used as training data.

This second training step finishes the preparation phase of the present invention. It has provided two different machine-learning models that may be used in the next phase, the deployment phase, in order to build or construct one or more new knowledge graphs from a new corpus of documents based on the auto-extracted core knowledge from the first document.

Next, method 100 comprises receiving 108 a set of second text documents. This set of second text documents—which may be, in a minimalistic version, only one document—represents a new corpus from which the new knowledge graph shall be constructed. Therefore, it is also useful that the set of second text documents relate to the same knowledge domain as the first document and the existing knowledge graph.

Additionally, method 100 comprises also determining 110 second embedding vectors from text segments—particularly short sequences, sentences, paragraphs, words—from documents from the set of second documents. These may be used as input in order to construct the new knowledge graph.

Moreover, method 100 comprises predicting 112 entities in the set of second text documents by using the set of second text documents and the determined second embedding vectors as inputs for the first trained machine-learning model. Based on this, also, edges are predicted.

Consequently, method 100 comprises predicting 114 edges—i.e., relationship data—in the set of second text documents by using the predicted entities (predicted by the first machine-learning model) and associated embedding vectors of the predicted entities as input for the second trained machine-learning model and building 116 triplets of the predicted entities and the related predicted edges (or vice versa which combined build the new knowledge graph. It may be noted that building triplets may only be one form of storing a knowledge graph. Other storage forms of knowledge graphs are possible.

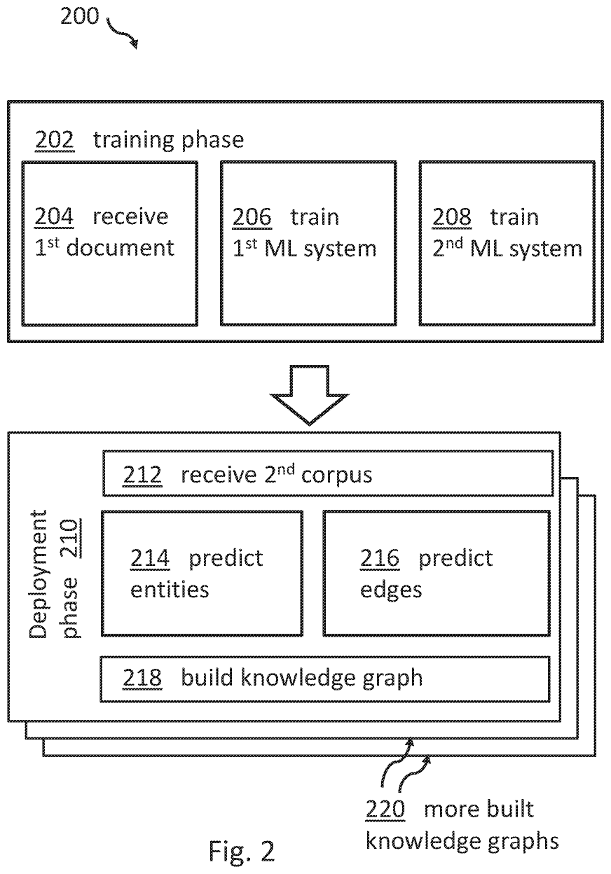

FIG. 2 depicts block diagram 200 of the method for building a new knowledge graph, in accordance with an embodiment of the present invention. In particular, the difference between the training phase 202 and the deployment phase 210 becomes more comprehensible. During the training phase 202, a first document of a plurality of first documents of a particular knowledge domain is received 204. Based on that, the first machine-learning model is trained, 206, using the first document(s) in which entities have been labeled. In a next step, the second machine-learning system is trained 208 by using, as input data, entity values and edge values of an existing knowledge graph of the same knowledge domain as the first document(s), as well as embedding vectors of the entity values and edge values. Hence, it can be concluded that by these activities of the training phase, the knowledge of the existing document—i.e., the first document and the existing knowledge graph—has been extracted and digested in order to support the deployment phase 210.

During the deployment phase 210, firstly a second corpus of documents—in particular, independent of the first document(s)—is received 212 from which entities are predicted 214 using the first machine-learning model. In a next step, edges—i.e., relationship data—are predicted 216 using the second machine-learning model. Once the entities and the related edges are known, triplets are built 218 comprising two entities and the related relationship edge, which can be stored as a record in a storage system. The combination of all triplets can then be managed as the newly built knowledge graph.

It may be noted that based on different received second corpuses, different knowledge graphs may be constructed and/or generated (more built knowledge graphs 220) based on the automatically extracted domain knowledge in the form of entities and edges from the first document(s) and the existing knowledge graph.

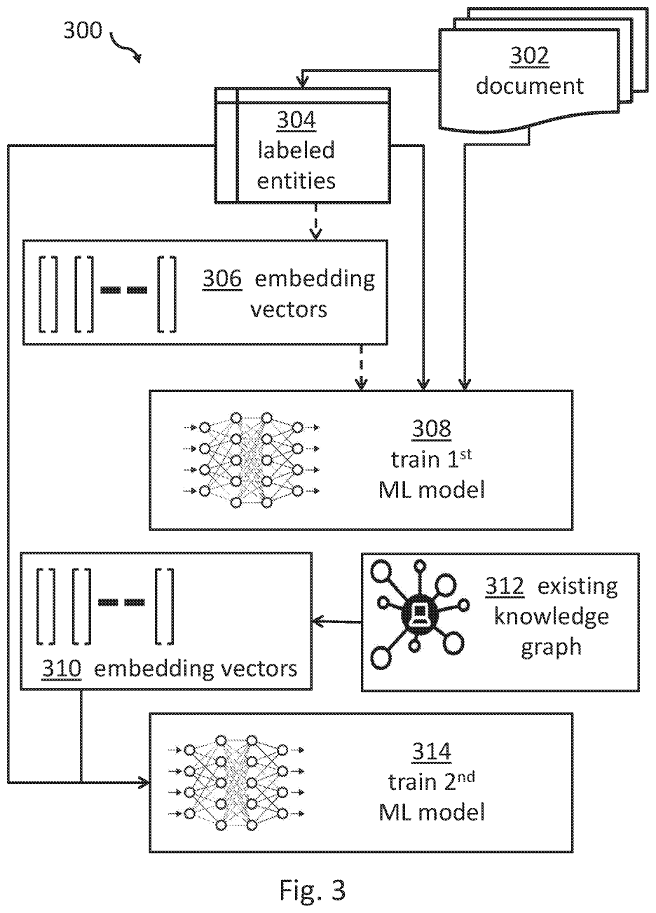

FIG. 3 depicts block diagram 300 of a training phase of the method, in accordance with an embodiment of the present invention. This figure details the training phase a bit more. Based on the received document 302, specific terms or phrases in the received document—or a plurality of documents, i.e., a corpus—are labeled representing the labeled entities 304. This task may be performed by a human expert particularly knowledgeable in the domain field. From this, the training of the first machine-learning model is performed, 308. Optionally, embedding vectors 306 of the identified entities 304 of the document 302 may be generated and used as input for the training 308 of the first machine-learning model.

In parallel, or after the training of the first machine-learning model, an existing knowledge graph 312 is used to determine embedding vectors 310 of the vertices values and edge values of the existing knowledge graph 312. The training 314 of the second machine-learning model is performed by using the determined embedding vectors 310 as well as the identified entities 304 of the first document(s) in order to predict relationships between the entities.

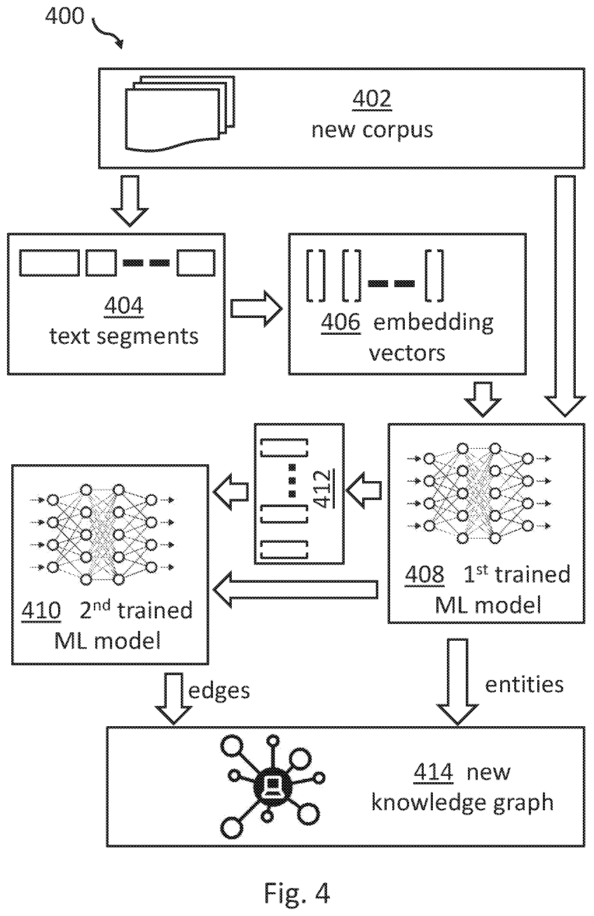

FIG. 4 depicts a block diagram 400 of a deployment phase of the method, in accordance with an embodiment of the present invention. This deployment phase starts with a new corpus 402, preferably from the same knowledge domain as the first received document (see FIG. 3) and the existing knowledge graph. From the new corpus of documents text segments 404 (word, word group, phrases, etc.) are identified from which embedding vectors 406 are determined. These are used as input data for the first trained machine-learning model 408 to predict entity values potentially to be used as vertices of a newly, to-be-constructed knowledge graph. From these predicted entities, embedding vectors 412 are determined to be used as input data—in particular together with the predicted entities from the first machine-learning system—in order to predict relationships between the entities using the second trained machine-learning model 410. The combination of the predicted entities and edges build the new knowledge graph 414.

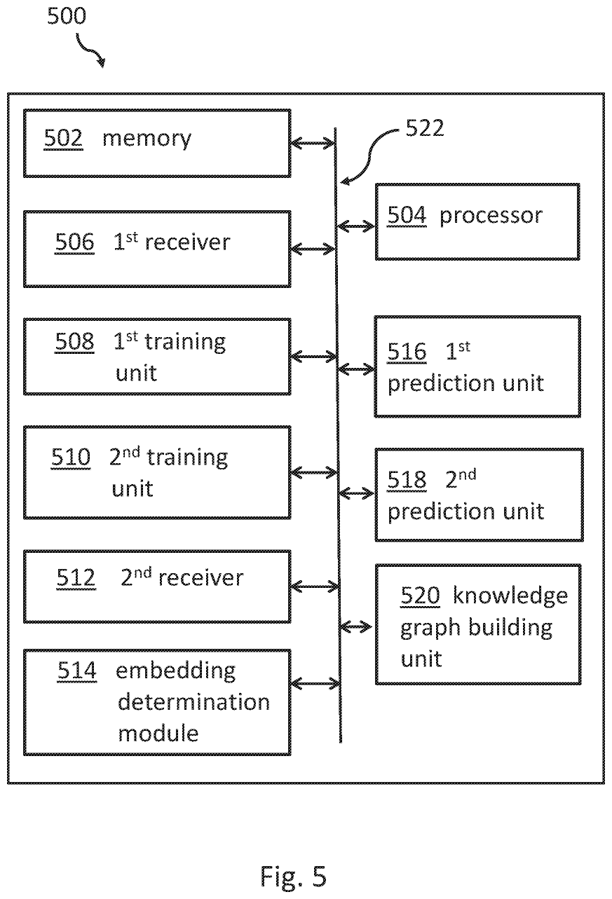

FIG. 5 depicts a block diagram of knowledge graph construction system 500, in accordance with an embodiment of the present invention. The knowledge graph construction system 500 comprises memory 502 and processor 504 communicatively coupled to each other. Thereby, processor 504, using program code stored in memory 502, is configured to receive a first text document—in particular, first receiver 506—to train of a first machine-learning system—in particular, by first training unit 508—to develop a first prediction model adapted to predict entities in the received text document, wherein as training data the text document with labeled entities from the text document is used, and to train of a second machine-learning system—in particular, by second training unit 510—to develop a second prediction model adapted to predict relationship data between the entities, wherein as training data entities and edges of an existing knowledge graph and determined first embedding vectors of the entities and the edges are used.

Furthermore, processor 504 using the program code is also configured to receive—in particular, using second receiver 512—a set of second text documents, determine—in particular, by embedding determination module 514—second embedding vectors from text segments from documents from the second set of documents, predict entities—in particular, by first prediction unit 516—in the set of second text documents by using the set of second text documents and the determined second embedding vectors as input for the first trained machine-learning model, predict edges—in particular, by second prediction unit 518—in the set of second text documents by using the predicted entities and associated embedding vectors of the predicted entities as input for the second trained machine-learning model, and build triplets—in particular, by knowledge graph building unit 520—of the predicted entities and the related predicted edges which combined build the new knowledge graph.

It may also be noted that the modules and units of the knowledge graph construction system 500 can be communicatively coupled to exchange signals and data directly. Or, memory 502, processor 504, receiver module 506, first training unit 508, second training unit 510, second receiver 512, embedding determination module 514, first prediction unit 516, second prediction unit 518, and knowledge graph building unit 520 are connected to knowledge graph construction system internal bus system 522 for data and signal exchange purposes to organize its cooperative functioning to achieve the goals of constructing the new knowledge graph.

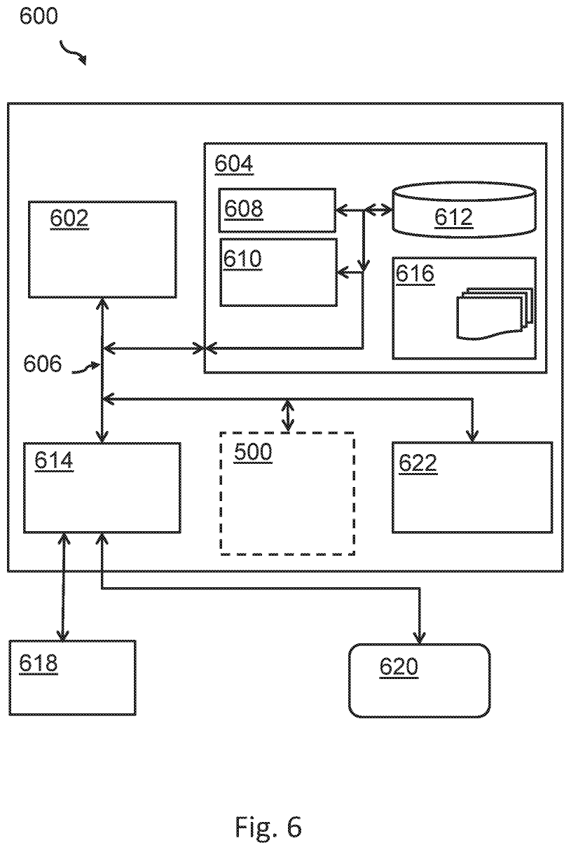

Embodiments of the invention may be implemented together with virtually any type of computer, regardless of the platform being suitable for storing and/or executing program code. FIG. 6 depicts a block diagram of computing device 600 comprising knowledge graph construction system 500, in accordance with an embodiment of the present invention.

Computing device 600 is only one example of a suitable computer system, and is not intended to suggest any limitation as to the scope of use or functionality of embodiments of the invention described herein, regardless, whether computer device 600 is capable of being implemented and/or performing any of the functionality set forth hereinabove. In computing device 600, there are components, which are operational with numerous other general purpose or special purpose computing system environments or configurations. Examples of well-known computing systems, environments, and/or configurations that may be suitable for use with computing device 600 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Computing device 600 may be described in the general context of computer system-executable instructions, such as program modules, being executed by computing device 600. Generally, program modules may include routines, programs, objects, components, logic, data structures, and so on that perform particular tasks or implement particular abstract data types, computing device 600 may be practiced in distributed cloud computing environments where tasks are performed by remote processing devices that are linked through a communications network. In a distributed cloud computing environment, program modules may be located in both, local and remote computer system storage media, including memory storage devices.

As shown in the figure, computing device 600 is shown in the form of a general-purpose computing device. The components of computing device 600 may include, but are not limited to, one or more processors or processing units 602, system memory 604, and bus 606 that couple various system components including system memory 604 to processor 602. Bus 606 represents one or more of any of several types of bus structures, including a memory bus or memory controller, a peripheral bus, an accelerated graphics port, and a processor or local bus using any of a variety of bus architectures. By way of example, and not limiting, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computing device 600 typically includes a variety of computer system readable media. Such media may be any available media that is accessible by computing device 600, and it includes both, volatile and non-volatile media, removable and non-removable media.

System memory 604 may include computer system readable media in the form of volatile memory, such as random-access memory (RPM) 608 and/or cache memory 610. Computing device 600 may further include other removable/non-removable, volatile/non-volatile computer system storage media. By way of example only, a storage system 612 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM, or other optical media may be provided. In such instances, each can be connected to bus 606 by one or more data media interfaces. As will be further depicted and described below, memory 604 may include at least one program product having a set (e.g., at least one) of program modules that are configured to carry out the functions of embodiments of the invention.

The program/utility, having a set (at least one) of program modules 616, may be stored in memory 604 by way of example, and not limiting, as well as an operating system, one or more application programs, other program modules, and program data. Each of the operating systems, one or more application programs, other program modules, and program data or some combination thereof, may include an implementation of a networking environment. Program modules 616 generally carry out the functions and/or methodologies of embodiments of the invention, as described herein.

Computing device 600 may also communicate with one or more external devices 618, such as a keyboard, a pointing device, display 620, etc.; one or more devices that enable a user to interact with computing device 600; and/or any devices (e.g., network card, modem, etc.) that enable computer system/server 600 to communicate with one or more other computing devices. Such communication can occur via Input/Output (I/O) interfaces 614. Still yet, computing device 600 may communicate with one or more networks such as a local area network (LAN), a general wide area network (WAN), and/or a public network (e.g., the Internet) via network adapter 622. As depicted, network adapter 622 may communicate with the other components of computing device 600 via bus 606. It should be understood that, although not shown, other hardware and/or software components could be used in conjunction with computing device 600. Examples, include, but are not limited to: microcode, device drivers, redundant processing units, external disk drive arrays, RAID systems, tape drives, and data archival storage systems, etc.

Additionally, knowledge graph construction system 500 for building a new knowledge graph may be attached to bus 606.

Programs described herein is identified based upon the application for which it is implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for building a new knowledge graph, the method comprising:
receiving a first text document;
training a first machine-learning system to develop a first prediction model adapted to predict first entities in the first text document, wherein labeled entities from the first text document are used as first training data;
training a second machine-learning system to develop a second prediction model adapted to predict first edges between the first entities, wherein existing entities and existing edges of an existing knowledge graph and determined first embedding vectors of the existing entities and the existing edges are used as second training data;
receiving a set of second text documents;
determining second embedding vectors from text segments from the set of second text documents;
predicting second entities in the set of second text documents by using the set of second text documents and the second embedding vectors as inputs for the first trained machine-learning model;
predicting second edges in the set of second text documents by using the second entities and associated embedding vectors of the second entities as input for the second trained machine-learning model; and
building triplets of the second entities and the related second edges to build a new knowledge graph.

2. The computer-implemented method according to claim 1, further comprising:
responsive to a second entity having a confidence level value below a predetermined entity threshold value, removing the second entity from the second entities.

3. The computer-implemented method according to claim 1, further comprising:
responsive to a second edge having a confidence level value below a predetermined edge threshold value, removing the second edge from the second edges.

4. The computer-implemented method according to claim 1, wherein the first machine-learning system and the second machine-learning system are trained using a supervised machine-learning method.

5. The computer-implemented method according to claim 4, wherein the supervised machine-learning method for the first machine-learning system is a random forest machine-learning method.

6. The computer-implemented method according to claim 1, wherein the second machine-learning system is selected from the group consisting of a neural network system, a reinforcement learning system, and a sequence-to-sequence machine-learning system.

7. The computer-implemented method according to claim 1, wherein an entity of the second entities is of an entity type.

8. The computer-implemented method according to claim 1, further comprising:
executing a parser for each predicted first entity; and
determining at least one entity instance.

9. The computer-implemented method according to claim 1, wherein the first document is a plurality of documents.

10. The computer-implemented method according to claim 1, further comprising:
storing provenance data to a document of the set of second text documents for the second entities and the second edges together with the triplets.

11. The computer-implemented method according to claim 1, wherein the set of second text documents is at least one of an article, a book, a newspaper, conference proceedings, a magazine, a chat protocol, a manuscript, handwritten notes, server log, and email thread.

12. The computer-implemented method according to claim 1, wherein, as input for the training of the first machine-learning model, determined first embedding vectors of the labeled entities are used as training data.

13. A knowledge graph construction system for building a knowledge graph, the knowledge graph construction system comprising:
one or more computer processors;
one or more computer readable storage media;
program instructions stored on the computer readable storage media for execution by at least one of the one or more processors, the program instructions comprising:
program instructions to receive a first text document;
program instructions to train a first machine-learning system to develop a first prediction model adapted to predict first entities in the first text document, wherein labeled entities from the first text document are used as training data;
program instructions to train a second machine-learning system to develop a second prediction model adapted to predict first edges between the first entities, wherein existing entities and existing edges of an existing knowledge graph and determined first embedding vectors of the first entities and the first edges are used as first training data;
program instructions to receive a set of second text documents;
program instructions to determine second embedding vectors from text segments from the set of second text documents;
program instructions to predict second entities in the set of second text documents by using the set of second text documents and the second embedding vectors as inputs for the first trained machine-learning model;
program instructions to predict second edges in the set of second text documents by using the second entities and associated embedding vectors of the second entities as inputs for the second trained machine-learning model; and
program instructions to build triplets of the second entities and the related second edges to build a new knowledge graph.

14. The knowledge graph construction system according to claim 13, further comprising:
responsive to a second entity having a confidence level value below a predetermined entity threshold value, program instructions to remove the second entity from the second entities.

15. The knowledge graph construction system according to claim 13, wherein the first machine-learning system and the second machine-learning system are trained using a supervised machine-learning method.

16. The knowledge graph construction system according to claim 13, wherein the second machine-learning system is selected from the group consisting of a neural network system, a reinforcement learning system, and a sequence-to-sequence machine-learning system.

17. The knowledge graph construction system according to claim 13, further comprising:
program instructions to execute a parser for each first entity; and
program instructions to determine at least one entity instance.

18. The knowledge graph construction system according to claim 13, further comprising:
program instructions to store provenance data to a document of the set of second text documents for the second entities and the second edges together with the triplets.

19. The knowledge graph construction system according to claim 13, wherein, as input for the training of the first machine-learning model, determined first embedding vectors of the labeled entities are used.

20. A computer program product for building a knowledge graph, the computer program product comprising:
one or more computer readable storage media and program instructions stored on the one or more computer readable storage media, the program instructions comprising:
program instructions to receive a first text document;
program instructions to train a first machine-learning system to develop a first prediction model adapted to predict first entities in the first text document, wherein labeled entities from the first text document are used as training data;
program instructions to train a second machine-learning system to develop a second prediction model adapted to predict first edges between the first entities, wherein existing entities and existing edges of an existing knowledge graph and determined first embedding vectors of the first entities and the first edges are used as first training data;
program instructions to receive a set of second text documents;
program instructions to determine second embedding vectors from text segments from the set of second text documents;
program instructions to predict second entities in the set of second text documents by using the set of second text documents and the second embedding vectors as inputs for the first trained machine-learning model;
program instructions to predict second edges in the set of second text documents by using the second entities and associated embedding vectors of the second entities as inputs for the second trained machine-learning model; and
program instructions to build triplets of the second entities and the related second edges to build a new knowledge graph.
